(19) United States
(12) Patent Application Publication
(10) Pub. No.: US 2026/0244152 A1
(43) Pub. Date: Aug. 20, 2026

(54) BOOKLET MANUFACTURING APPARATUS AND IMAGE FORMING SYSTEM

(71) Applicant: CANON KABUSHIKI KAISHA, Tokyo (JP)

(72) Inventors: TAKUYA OKA, Shizuoka (JP); KODAI HAYASHI, Shizuoka (JP); TAKU WATANABE, Shizuoka (JP)

(21) Appl. No.: 19/543,731

(22) Filed: Feb. 18, 2026

(30) Foreign Application Priority Data
Feb. 19, 2025 (JP) 2025-025405

(51) Int. Cl. G03G 21/12; B42C 1/12; G03G 15/00; G03G 21/00; G03G 21/10

(52) U.S. Cl. CPC G03G 21/12; B42C 1/12; G03G 15/6544; G03G 15/6585; G03G 21/0017; G03G 21/105; G03G 2215/00835; G03G 2215/00936

(57) ABSTRACT

A booklet manufacturing apparatus and an image forming system are capable of preventing a residual toner leak from a residual toner container. An image forming system includes a residual toner storage portion configured to store residual toner collected by a collection member and including a toner discharge port for discharging the residual toner. The toner discharge port is provided on one side in a rotational axis direction of an image bearing member. A bonding toner image transferred to a recording material bonds a plurality of recording media, and this allows a booklet to be manufactured. The bonding toner image is formed at an end portion of the recording material that is located on the other side in the rotational axis direction.

### BACKGROUND

### Field of the Technology

The present disclosure relates to a booklet manufacturing apparatus for manufacturing a bonded print product such as a booklet, and an image forming system including an electrophotographic image forming apparatus and a booklet manufacturing apparatus.

### Description of the Related Art

An image forming apparatus using an electrophotographic method (an electrophotographic process) uniformly charges a photosensitive drum, which is an example of an image bearing member, and selectively exposes the charged photosensitive drum, thereby forming an electrostatic image on the photosensitive drum. The electrostatic image formed on the photosensitive drum is visualized as a toner image by attachment of toner thereto. Then, the toner image formed on the photosensitive drum is transferred to a recording medium such as recording paper or a plastic sheet, and, further, the toner image is fixed to the recording medium by applying heat and a pressure to the toner image transferred on the recording medium. Image recording is carried out by that.

Such an image forming apparatus generally involves replenishment of a developer and maintenance of various process units. One measure in practical use for facilitating the developer replenishment work and the maintenance of various process units is to put a photosensitive drum, a charging unit, a development unit, a cleaning unit, and the like together in a frame member as one cartridge, and prepare them as a process cartridge detachably attachable to the main body of the image forming apparatus. According to the process cartridge method, an image forming apparatus excellent in usability can be provided.

Known examples of such a process cartridge include a configuration equipped with units such as a cleaning unit having a photosensitive drum, a development unit having a development member, and a toner unit that supplies toner.

For the above-described cleaning unit, a cleaning blade method has been widely used for reasons of, for example, space saving, designability, and mechanism simplicity. This method places an elastic cleaning blade into abutment with the photosensitive drum in a predetermined region to form a nip portion, thereby removing residual toner remaining on the surface of the rotating photosensitive drum. The removed toner (residual toner) is collected into a residual toner container of the cleaning unit.

PTL 1 (Japanese Patent Laid-Open No. 2004-163821) describes a configuration that prevents a toner leak from a residual toner container by providing a residual toner conveyance unit in the above-described residual toner container and discharging residual toner out of the apparatus via a residual toner discharge port.

Further, PTL 2 (Japanese Patent Laid-Open No. 2023-164082) describes a booklet manufacturing apparatus that manufactures a booklet by overlaying recording media on which bonding toner images for bonding the recording media are formed, and heating and pressing the bonding toner images.

### SUMMARY

According to some embodiments of the present disclosure, an image forming system includes a rotatable image bearing member, a development unit configured to be able to supply toner to the image bearing member and develop a toner image and a bonding toner image, a transfer unit configured to transfer the toner image on the image bearing member to a recording material, a collection member configured to collect residual toner remaining on the image bearing member without being transferred to the recording material, a residual toner storage portion configured to store the residual toner collected by the collection member and including a toner discharge port used to discharge the residual toner and provided on one side in a rotational axis direction of the image bearing member, and a conveyance member configured to convey the residual toner toward the toner discharge port by moving the residual toner stored in the residual toner storage portion in the rotational axis direction. The bonding toner image transferred to the recording material by the transfer unit bonds a plurality of recording media, and this allows a booklet to be manufactured. The bonding toner image is formed at an end portion of the recording material that is located on the other side in the rotational axis direction.

According to another aspect of the present disclosure, a booklet manufacturing apparatus is connectable to an image forming apparatus. The image forming apparatus includes a rotatable image bearing member, a development unit configured to be able to supply toner to the image bearing member and develop a toner image and a bonding toner image, a transfer unit configured to transfer the toner image on the image bearing member to a recording material, a collection member configured to collect residual toner remaining on the image bearing member without being transferred to the recording material, a residual toner storage portion configured to store the residual toner collected by the collection member and including a toner discharge port used to discharge the residual toner and provided on one side in a rotational axis direction of the image bearing member, and a conveyance member configured to convey the residual toner toward the toner discharge port by moving the residual toner stored in the residual toner storage portion in the rotational axis direction. The booklet manufacturing apparatus includes a heater configured to heat the bonding toner image. A booklet is manufactured by heating the bonding toner image transferred to the recording material by the transfer unit using the heater and bonding a plurality of recording media using a bonding force of the heated bonding toner image. The heater is disposed on the other side in the rotational axis direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional diagram of an image forming apparatus and a post-processing apparatus according to a first embodiment.

FIGS. 2A to 2D are schematic diagrams illustrating a sheet alignment method of the post-processing apparatus according to the first embodiment.

FIGS. 3A to 3C are schematic cross-sectional diagrams illustrating a thermocompression bonding unit according to the first embodiment.

FIG. 4 is a schematic cross-sectional diagram of a process cartridge according to the first embodiment.

FIG. 5 is a schematic diagram illustrating a printing region of a bonding portion according to the first embodiment.

FIGS. 6A and 6B are schematic diagrams of a residual toner storage portion according to the first embodiment.

FIG. 7 is a schematic diagram illustrating a positional relationship between a residual toner discharge port and the printing region of the bonding layer according to the first embodiment.

FIGS. 8A and 8B are schematic diagrams illustrating a positional relationship between the residual toner discharge port and the printing region of the bonding layer according to comparison example 1.

FIG. 9 is a schematic diagram of a residual toner storage portion according to a second embodiment.

FIG. 10 is a schematic diagram illustrating a positional relationship between a residual toner receiving member and the printing region of the bonding layer according to the second embodiment.

### DESCRIPTION OF THE EMBODIMENTS

In the following description, various exemplary embodiments, features, and aspects of the present disclosure will be described in detail by way of example with reference to the drawings. However, the dimensions, the materials, the shapes, the relative layout, and the like of components described in these embodiments are not intended to limit the scope of the present disclosure only thereto unless otherwise especially described.

Further, for materials, shapes, and the like regarding members described once in the following description, the initial descriptions will also apply throughout the text, unless specifically described otherwise again. In particular, well-known techniques or publicly-known techniques in the present technical field can be employed for configurations and processes not specifically illustrated or described. Further, redundant descriptions may be omitted.

### First Embodiment

### <Apparatus and Operation>

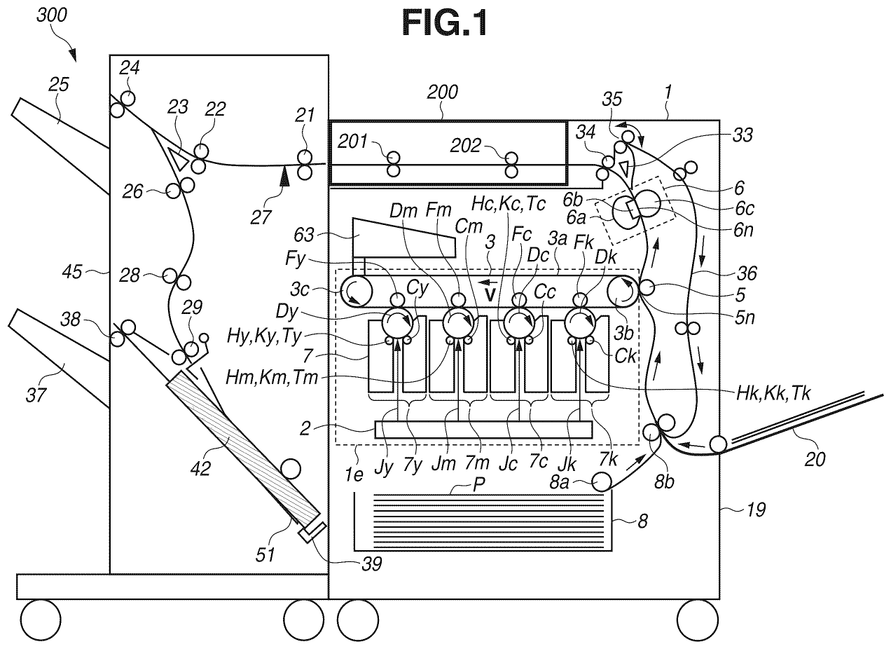

First, an image forming apparatus will be described with reference to FIG. 1. FIG. 1 is a schematic diagram illustrating a cross-section of an image forming apparatus 1 according to a first embodiment.

As illustrated in FIG. 1, the image forming apparatus 1 includes a sheet cassette 8 as a sheet storage portion that stores a sheet P as a recording material, an image forming unit 1e as an image forming unit, a fixing device 6 as a fixing unit, and a housing 19 that houses them. The image forming apparatus 1 has a printing function of forming a toner image by the image forming unit 1e on the sheet P fed from the sheet cassette 8, and producing a print product subjected to fixing processing by the fixing device 6. In the present embodiment, the largest size in a conveyance direction for the sheet P on which an image can be formed is an A4 size (297 mm in length×210 mm in width) and the smallest size thereof is an A5 size (210 mm in length×148 mm in width). The sheet conveyance speed is 300 mm/sec (millimeter/second).

The sheet cassette 8 is inserted extractably from the housing 19 in the lower portion of the image forming apparatus 1, and stores a large number of sheets P. The sheets P stored in the sheet cassette 8 are fed from the sheet cassette 8 by a sheet feeding roller 8a as a sheet feeding unit, and are conveyed by a conveyance roller pair 8b. Further, sheets set in a multi-tray 20 can also be fed one by one. In the present embodiment, the sheets P are set in the sheet cassette 8 based on the centers of the sheets P.

The image forming unit 1e is a tandem-type electrophotographic unit that includes four process cartridges 7y, 7m, 7c, and 7k, a scanner unit 2, and a transfer unit 3. The process cartridge refers to a unit in which a plurality of components involved in an image forming process is integrated as one unit collectively replaceably.

Each of the process cartridges 7y, 7m, 7c, and 7k has a substantially common configuration except for toner types stored in four toner storage portions Ky, Km, Kc, and Kk. More specifically, the process cartridges 7y, 7m, 7c, and 7k include photosensitive drums Dy, Dm, Dc, and Dk, each of which is an image bearing member, charging rollers Cy, Cm, Cc, and Ck, each of which is a charging device, and the toner storage portions Ky, Km, Kc, and Kk, which store the toner and supply the toner to the photosensitive drums Dy, Dm, Dc, and Dk, respectively. In the present embodiment, each of the process cartridges 7y, 7m, 7c, and 7k is inserted from the front side (the front side of the page of FIG. 1) to the rear side (the rear side of the page of FIG. 1) of the image forming apparatus 1.

The four toner storage portions Ky, Km, Kc, and Kk store printing toner of yellow (Ty), magenta (Tm), cyan (Tc), and black (Tk), respectively, as toner for forming a visible image on the sheet P. In the present embodiment, the toner for forming a visible image is also used as bonding toner serving as a powder adhesive for performing bonding processing after printing.

The scanner unit 2 is disposed below the process cartridges 7y, 7m, 7c, and 7k and above the sheet cassette 8. The scanner unit 2 is an exposure unit according to the present embodiment that irradiates the photosensitive drums Dy, Dm, Dc, and Dk of the process cartridges 7y, 7m, 7c, and 7k with laser light beams Jy, Jm, Jc, and Jk, respectively, to write electrostatic latent images thereon.

The transfer unit 3 includes a transfer belt 3a as an intermediate transfer member (a secondary photosensitive drum). The transfer belt 3a is a belt member wound around a secondary transfer inner roller 3b and a tension roller 3c, and the outer peripheral surface thereof faces the respective photosensitive drums Dy, Dm, Dc, and Dk of the process cartridges 7y, 7m, 7c, and 7k. Primary transfer rollers Fy, Fm, Fc, and Fk are disposed at positions corresponding to the photosensitive drums Dy, Dm, Dc, and Dk, respectively, on the inner peripheral side of the transfer belt 3a. Further, a secondary transfer roller 5 as a transfer unit is disposed at a position facing the secondary transfer inner roller 3b. A transfer nip 5n between the secondary transfer roller 5 and the transfer belt 3a is a transfer portion (a secondary transfer portion) where the toner image is transferred from the transfer belt 3a to the sheet P. The fixing device 6 is disposed above the secondary transfer roller 5.

The fixing device 6 includes a tubular fixing film (endless belt) 6a as a heating rotational member, and a pressing roller 6c as a pressing member. The fixing device 6 includes a heater 6b as a heating unit in contact with the inner surface of the fixing film 6a, and the pressing roller 6c as a pressing rotational member that forms a fixing nip 6n together with the heater 6b via the fixing film 6a.

Next, the operation of the image forming apparatus 1 will be described also referring to FIG. 1. When data of an image to be printed and an instruction to print it are input to the image forming apparatus 1, a control unit (not illustrated) of the image forming apparatus 1 starts a series of operations of conveying the sheet P and forming the image on the sheet P (an image forming operation). In the image forming operation, first, the sheet P is fed one by one from the sheet cassette 8, and is conveyed toward the transfer nip 5n via the conveyance roller pair 8b.

In parallel with the feeding of the sheet P, the process cartridges 7y, 7m, 7c, and 7k are driven sequentially, and the photosensitive drums Dy, Dm, Dc, and Dk are rotationally driven. At this time, the surfaces of the photosensitive drums Dy, Dm, Dc, and Dk are uniformly charged by the charging rollers Cy, Cm, Cc, and Ck, respectively. Further, the scanner unit 2 irradiates the respective photosensitive drums Dy, Dm, Dc, and Dk of the process cartridges 7y, 7m, 7c, and 7k with laser light modulated based on the image data, thereby forming electrostatic latent images on the surfaces of the photosensitive drums Dy, Dm, Dc, and Dk. Next, the electrostatic latent images on the photosensitive drums Dy, Dm, Dc, and Dk are developed as toner images by toner borne on development rollers Hy, Hm, He, and Hk in the toner storage portions Ky, Km, Kc, and Kk of the process cartridges 7y, 7m, 7c, and 7k, respectively.

The transfer belt 3a rotates in the counterclockwise direction (an arrow V) in FIG. 1. The toner images formed in the process cartridges 7y, 7m, 7c, and 7k are primary-transferred from the photosensitive drums Dy, Dm, Dc, and Dk to the transfer belt 3a with the aid of electric fields formed between the photosensitive drums Dy, Dm, Dc, and Dk and the primary transfer rollers Fy, Fm, Fc, and Fk, respectively.

The toner images borne on the transfer belt 3a and reaching the transfer nip 5n are secondary-transferred to the conveyed sheet P with the aid of an electric field formed between the secondary transfer roller 5 and the secondary transfer inner roller 3b.

In a case where the toner image is supposed to contain toner of all the four colors in the toner image formed on the sheet P after the secondary transfer, the black toner Tk is placed at a position closest to the sheet P. The cyan toner Tc is placed on the black toner Tk, the magenta toner Tm is placed on the cyan toner Tc, and the yellow toner Ty is placed at a position farthest from the sheet P.

After that, the sheet P is conveyed to the fixing device 6 and subjected to heat fixing processing. More specifically, the toner image on the sheet P is heated and pressed as the sheet P passes through the fixing nip 6n, and this causes the toner Ty, Tm, Tc, and Tk to be melted and then solidified after that, thereby allowing a fixed image to be acquired on the sheet P.

A switching guide 33 is a flap-like guide member for switching the conveyance direction when one of a single-sided printing mode of forming an image on one side of the sheet P and a double-sided printing mode of forming images on both sides of the sheet P is selected. In the case of the single-sided printing mode, the switching guide 33 conveys the sheet P toward a sheet discharge roller pair 34. On the other hand, in the case of the double-sided printing mode, the switching guide 33 conveys the sheet P toward a switchback roller pair 35, and the switchback roller pair 35 reverses the rotational direction after discharging the sheet P up to the trailing edge of the sheet P, by which the sheet P is conveyed toward a double-sided conveyance path 36 for double-side printing. The sheet P conveyed to the double-sided conveyance path 36 passes through the secondary transfer unit and the fixing unit again, as a result of which an image is formed on an unprinted sheet surface, and the sheet P is conveyed toward the sheet discharge roller pair 34 by the switching guide 33. Further, the sheet P reaches a post-processing apparatus (a booklet manufacturing apparatus) 300 connected to the image forming apparatus 1 via an intermediate conveyance unit 200, which includes the sheet discharge roller pair 34 and conveyance roller pairs 201 and 202. The post-processing apparatus 300 is a floor-standing type, and includes a sheet alignment unit and a thermocompression bonding unit 51 in a lower portion thereof. The thermocompression bonding unit 51 heats and presses an aligned sheet bundle for a predetermined time. The thermocompression bonding unit 51 heats and presses a bonding toner image on the sheet P, thereby causing the bonding toner image to exert a bonding force. In the present example, the sheet conveyance speed in the intermediate conveyance unit 200 and the post-processing apparatus 300 is 600 mm/sec.

The sheet P conveyed from the intermediate conveyance unit 200 is handed over to a conveyance roller pair 21 of the post-processing apparatus 300. The conveyance rollers 22 speed up the sheet P at a predetermined timing based on a time when the trailing edge passes through an inlet sensor 27. In a case where the discharge destination of the sheet P is a sheet discharge upper tray 25, the sheet P is slowed down to a predetermined sheet discharge speed at a stage that the sheet trailing edge reaches between the conveyance rollers 22 and reversing rollers 24, and is discharged onto the sheet discharge upper tray 25.

In a case where the discharge destination of the sheet P is a sheet discharge lower tray 37, the sheet conveyance is temporarily stopped at a timing when the sheet trailing edge exits from a backflow prevention valve 23, which is biased in the clockwise direction in FIG. 1 by a not-illustrated spring, and, after that, the sheet P is switched back and conveyed to inner sheet discharge rollers 26.

The sheet P conveyed from the inner sheet discharge rollers 26 is transmitted to kicking rollers 29 via intermediate conveyance rollers 28, and is then conveyed to an intermediate stacking unit 42. Vertical-alignment reference plates 39 are disposed at the most downstream portion of the intermediate stacking unit 42, and a sheet bundle is aligned by bringing the sheet edges in the conveyance direction in abutment with them.

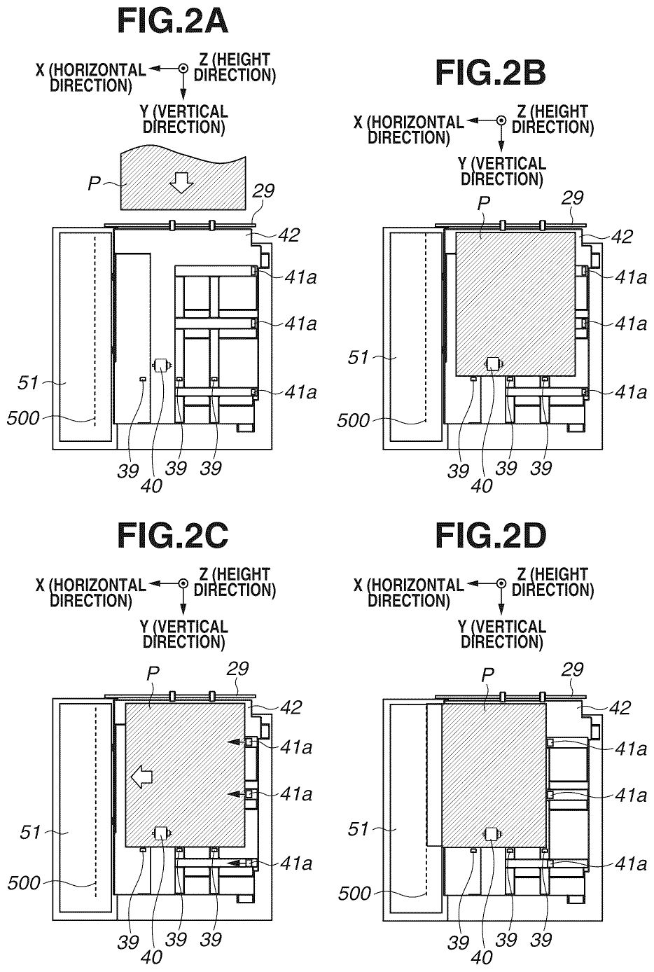

A sheet alignment method will be described with reference to FIGS. 1 and 2A to 2D. Now, the vertical direction, the horizontal direction, and the height direction of the sheet P are assumed to be a Y direction, an X direction, and a Z direction, respectively. (A) On the intermediate stacking unit 42, a semicircular roller 40 for pushing in the sheet P exiting out of the kicking rollers 29 against the vertical-alignment reference plates 39 is rotatably supported. The semicircular roller 40 conveys the sheet P toward the vertical-alignment reference plates 39 at a predetermined timing. (B) The semicircular roller 40 is adjusted to such a conveyance pressure that the semicircular roller 40 slips on the sheet P after the sheet P is brought into abutment with the vertical-alignment reference plates 39. After the sheet P reaches the vertical-alignment reference plates 39, (C) horizontal-alignment joggers 41a perform an alignment operation until the sheet P abuts a horizontal-alignment reference plate 500 (dotted line), and then (D) arranges the sheet bundle to a predetermined position. The operations (C) and (D) are performed collectively for each predetermined number of sheets in conjunction with a binding operation by the thermocompression bonding unit 51 serving as a sheet bonding unit. The thermocompression bonding unit 51 performs thermocompression bonding processing on the plurality of sheets P, thereby creating a sheet bundle bound at the left end portion or the right end portion. A highly accurately aligned sheet bundle can be manufactured by subjecting the vertically and horizontally aligned sheet bundle to the heating and pressing processing using the thermocompression bonding unit 51.

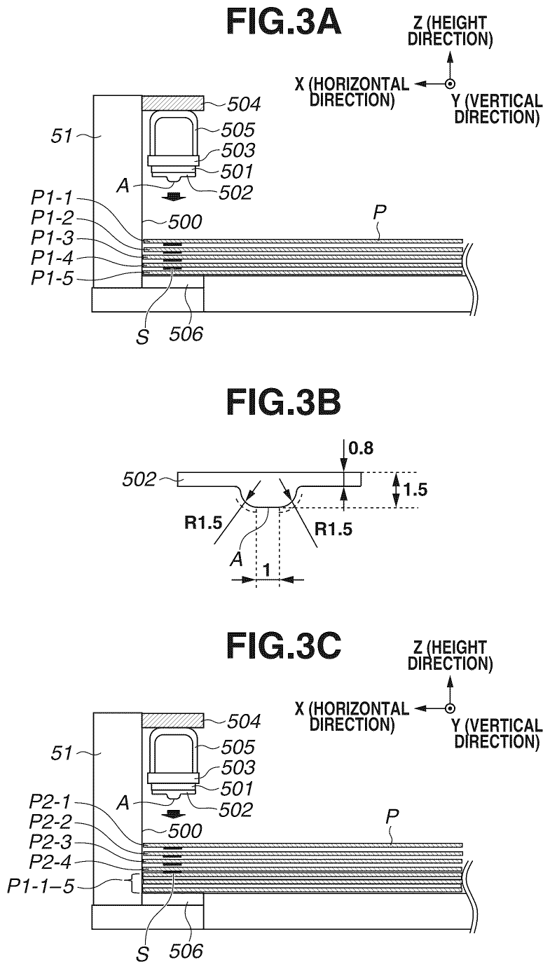

The structure of the thermocompression bonding unit 51 will be further described. FIG. 3A is a cross-sectional diagram of the thermocompression bonding unit 51. In the thermocompression bonding unit 51, a heating plate 502 made from aluminum is disposed on a ceramic heater 501 including a built-in heating element as a heat source thereof. The dimension of the ceramic heater 501 is 1.0 mm in thickness, 8.0 mm in width, and 350 mm in length. The temperature of the ceramic heater 501 can be controlled to any set temperature by a not-illustrated temperature detection unit and a not-illustrated power application unit supported on a heater support member 503, and the set temperature thereof is adjusted in such a manner that a pressing portion A of the heating plate 502 has a surface temperature of 200° C. (Celsius). Now, the provision of the pressing portion A to the heating plate 502 allows the thermocompression bonding unit 51 to concentrate heat and a pressure thereof only on the binding position of the sheet bundle, thereby allowing the thermocompression bonding unit 51 to efficiently perform the heating and pressing processing. Further, the ceramic heater 501 is supported by the heater support member 503 made from resin. A pressing lever 504 receives motive power from a not-illustrated driving source to push down the thermocompression bonding unit 51 in a −Z direction (downward) to apply a pressing force to the sheet bundle. The pressing force of the pressing lever 504 is transmitted via a metal stay 505 as a rigid body, and is applied to the sheet bundle P at a total pressure of 30 kgf. Then, a pressing plate 506 is 2.0 mm in thickness and is made from silicone rubber, and is a member for stably receiving the pressing force. The thermocompression bonding unit 51 presses the sheet bundle for two seconds, and is separated therefrom after that. Further, in the present embodiment, the bonding processing can be applied to up to five sheets P having a grammage of up to 90 g/m² at a time. FIG. 3B illustrates a cross-sectional shape of the heating plate 502, and the pressing portion A includes a flat portion of 1.0 mm and curved portions with a radius of R1.5 on both sides thereof. Further, the length of the heating plate 502 in the Y direction is 300 mm.

Further, as illustrated in FIG. 3C, a product containing many sheets in the booklet can be manufactured by applying the bonding processing using the thermocompression bonding unit 51 (P1-1 to 5), and, after that, sequentially stacking the sheets P (P2-1 to 4) thereon and bonding the sheets P1-1 to 5 and the sheets P2-1 to 4 together. In the present embodiment, a booklet containing up to 50 sheets P can be manufactured by feeding five sheets P first time and feeding up to four sheets for each subsequent feeding after that. During a continuous operation, the sheet P is fed to the thermocompression bonding unit 51, and the thermocompression bonding unit 51 repeats a lowering operation, a pressing operation (two seconds), and a rising operation, thereby achieving efficient booklet manufacturing.

After completion of the bonding processing by the thermocompression bonding unit 51, a not-illustrated bundle discharge guide is translated from a waiting position in a direction toward a sheet discharge port 45, thereby pushing out the sheet bundle. Bundle discharge rollers 38 are provided at the sheet discharge port 45.

The bundle discharge guide stops at a position where the leading edge of the sheet bundle moves slightly beyond the bundle discharge rollers 38, and returns again to the waiting position. The bundle discharge rollers 38 discharge the sheet bundle received from the bundle discharge guide to the sheet discharge lower tray 37.

### <Process Cartridge>

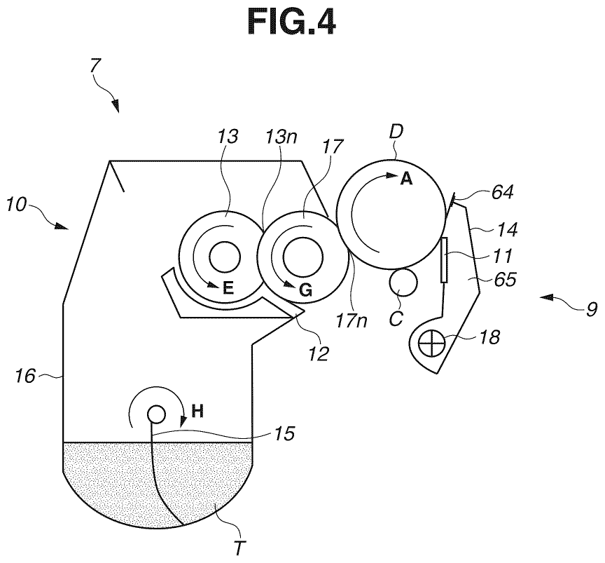

Referring to FIG. 4, the process cartridge 7 mountable onto the image forming apparatus 1 according to the present embodiment will be described in detail. In the present embodiment, the basic configuration and operation of the process cartridge 7 for each color are the same, except for the type (color) of a developer stored therein. Therefore, in the following description, the process cartridge 7 will be collectively described omitting indexes y, m, c, and k, which are added to a reference numeral to indicate which color the element is provided for, unless such distinction is desired.

The process cartridge 7 includes a photosensitive drum unit 9, which includes the photosensitive drum D, and a development unit 10, which includes a development roller 17 and the like.

The photosensitive drum unit 9 includes a cleaning frame member 14 as a frame member that supports various elements in the photosensitive drum unit 9. The photosensitive drum D is rotatably installed on the cleaning frame member 14 via a not-illustrated bearing. In reaction to transmission of a driving force of a driving motor as a driving source (not illustrated) to the photosensitive drum unit 9, the photosensitive drum D is rotationally driven in a direction indicated by an arrow A (the clockwise direction) according to the image forming operation.

The charging roller C, which is a charging unit, is driven to rotate due to pressure contact of a roller portion thereof made from conductive rubber with the photosensitive drum D. Now, a predetermined direct-current voltage is applied from a charging power source (not illustrated) to the core metal of the charging roller C in a charging process, by which a uniform dark-area potential (Vd) is formed on the surface of the photosensitive drum D. A spot pattern of laser light generated in correspondence with the image data due to the laser light emitted from the above-described scanner unit 2 exposes the photosensitive drum D, and the exposed portion loses charges on the surface due to carriers from a carrier generation layer and the potential thereof is reduced. As a result, an electrostatic latent image in which the exposed portion has a predetermined light-area potential (VI) and the unexposed portion has a predetermined dark-area potential (Vd) is formed on the photosensitive drum D. In the present embodiment, assume that the longitudinal width of the photosensitive drum D is 257 mm, and a region where the latent image is formed on the surface of the photosensitive drum D is a width of 208 mm with its center aligned with the longitudinal center of the photosensitive drum D. Further, assume that Vd and Vl are expressed as Vd=−500 V and Vl=−100 V (volts).

A cleaning blade (a collection member) 11, the charging roller C, and a collection sheet member 64 are disposed in the photosensitive drum unit 9 in contact with the circumferential surface of the photosensitive drum D. Transfer residual toner removed from the surface of the photosensitive drum D by the cleaning blade 11 falls under the gravitational force, and is collected into a residual toner storage portion 65 in the cleaning frame member 14. The collection sheet member 64 prevents the stored toner from leaking out from the photosensitive drum unit 9. The residual toner stored in the residual toner storage portion 65 is discharged out of the cleaning frame member 14 with the aid of a rotation of a residual toner screw 18 disposed in the cleaning frame member 14.

In the present embodiment, the cleaning blade 11 is made from urethane rubber.

On the other hand, the development unit 10 includes the development roller 17 (a developer bearing member), a development blade 12, a toner supply roller (a supply unit) 13, toner T, and a toner storage chamber 16, which is a chamber storing the toner T.

The development blade 12 is in counter contact with the development roller 17, and regulates the coating amount of the toner supplied by the toner supply roller 13 and provides charges. The development blade 12 is made of a thin plate-like member, and forms an abutment pressure using the spring elasticity of the thin plate, with the surface thereof in contact and abutment with the toner T and the development roller 17. The toner T is triboelectrically charged due to sliding friction between the development blade 12 and the development roller 17 to be provided with charges, and the layer thickness thereof is regulated at the same time. In the present embodiment, a leaf spring-shaped thin plate made of a stainless steel (SUS) is used as the development blade 12. However, the development blade 12 is not limited thereto, and may be a thin plate made of metal such as phosphor bronze or aluminum. Further, the development blade 12 with the surface thereof covered with a thin film made from polyamide elastomer, urethane rubber, urethane resin, or the like may also be used. Further, a predetermined voltage is applied from a blade bias power source (not illustrated) to the development blade 12 to stabilize the toner coating, and Vb=−400 V is applied as the blade bias.

The development roller 17 and the photosensitive drum D each rotate in such a manner that the surfaces thereof move in the same direction as each other at a facing portion 17n (a contact portion or a development portion) (the photosensitive drum D indicated by the arrow A, and the development roller 17 indicated by an arrow G). In the present embodiment, in reaction to a predetermined direct-current voltage applied from a development power source (not illustrated) to the development roller 17, the toner T negatively charged due to triboelectric charging is transferred only to a light-area potential portion and visualizes the electrostatic latent image at the facing portion 17n in contact with the photosensitive drum D due to a potential difference therebetween.

The toner supply roller 13 is arranged so as to form a predetermined nip portion 13n on the circumferential surface of the development roller 17. The toner supply roller 13 rotates in a direction indicated by an arrow E (the counterclockwise direction in FIG. 4). The toner supply roller 13 according to the present embodiment is an elastic sponge roller in which a foamed body is formed around the outer periphery of a conductive core metal. The toner supply roller 13 and the development roller 17 are in contact with each other with a predetermined interference amount, and rotate so as to move in opposite directions from each other at the nip portion 13n. Due to this rotation motion, the toner T is supplied to the development roller 17 by the toner supply roller 13, and development residual toner remaining on the development roller 17 is scraped off In the present embodiment, the toner supply roller 13 is driven to rotate at a rotation speed equal to 100% of that of the development roller 17, and a direct-current (DC) bias is applied so that the toner supply roller 13 has a potential difference of Δ=−50 V with respect to the developing roller 17. In other words, Vdc=−300 V and Vdr=−350 V are applied to the development roller 17 and the toner supply roller 13, respectively. This arrangement can create such a state that the toner T can be easily electrically supplied from the toner supply roller 13 to the development roller 17. In the present embodiment, the development roller 17 and the toner supply roller 13 are both 15 mm in outer diameter.

A toner stirring member 15 is provided in the toner storage chamber 16. The toner stirring member 15 has a sheet-like member that rotates in a direction indicated by an arrow H, and stirs the toner T stored in the toner storage chamber 16 and also conveys the toner T toward the upper portion of the toner supply roller 13.

### <Toner>

The toner Ty, Tm, Tc, and Tk serving as both printing and bonding purposes will be described. The toner Ty, Tm, Tc, and Tk containing thermoplastic resin can be used in the present disclosure. Resin usable as this thermoplastic resin is not especially limited, and examples thereof include known thermoplastic resins such as a polyester resin, a vinyl resin, acrylic resin, a styrene acrylic resin, polyethylene, polypropylene, polyolefin, an ethylene-vinyl acetate copolymer resin, and an ethylene-acrylic acid copolymer resin. The toner T may contain a plurality of kinds of resin among them.

The toner Ty, Tm, Tc, and Tk can further contain a wax. Examples usable as this wax include known waxes such as ester waxes, which are esters of alcohol and acid, and hydrocarbon waxes such as paraffin wax.

The toner Ty, Tm, Tc, and Tk contains a colorant. Examples usable as this colorant include known colorants such as a yellow colorant for the yellow toner Ty, a magenta colorant for the magenta toner Tm, a cyan colorant for the cyan toner Tc, and a black colorant for the black toner Tk.

The toner Ty, Tm, Tc, and Tk may contain a magnetic material, a charge control agent, a wax, and an external additive. Further, commonly-used printing toner may be used as the toner Ty, Tm, Tc, and Tk as long as the toner satisfies adhesiveness.

The toner T in the present embodiment is non-magnetic one component spherical toner charged to have a negative polarity as a normal polarity, and having a particle diameter of 7 μm.

### <Printing Region of Bonding Layer>

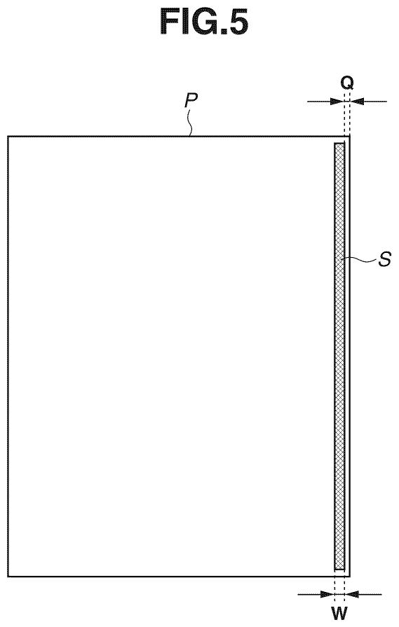

FIG. 5 is a schematic diagram illustrating a printing region S of a bonding layer using the toner Ty, Tm, Tc, and Tk according to the present embodiment. As indicated by a hatched portion, the printing region S of the bonding layer is formed as an image at an end portion on the long edge of the sheet P, thereby allowing a booklet bound along the long edge to be manufactured as a product at the time of booklet manufacturing by the post-processing apparatus 300. In this example, a width W of the printing region S of the bonding layer is set to 5.0 mm and a distance Q from the paper edge is set to 2.0 mm. In the present embodiment, a toner amount (an application amount) per unit area for one toner color used for the bonding layer is set to 0.5 mg/cm².

### <Residual Toner Conveyance Configuration>

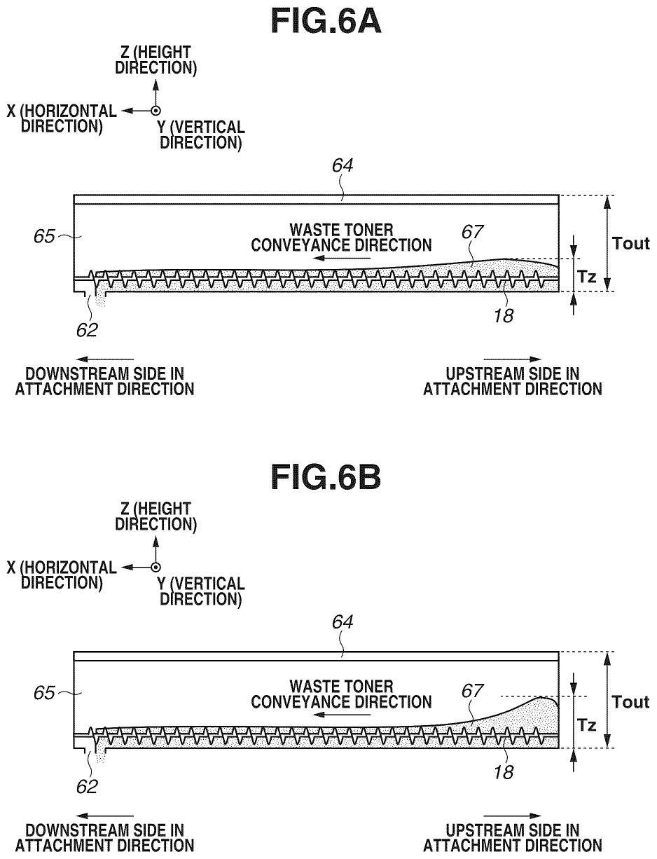

A residual toner conveyance configuration will be described with reference to FIGS. 6A and 6B. The transfer residual toner removed from the surface of the photosensitive drum D (the surface of the image bearing member) by the cleaning blade 11 falls under the gravitational force, and is stored in the residual toner storage portion 65 in the cleaning frame member 14.

The residual toner screw 18 is inserted through inside the residual toner storage portion 65. The residual toner screw 18 is rotationally driven by a driving force transmitted form the apparatus main body of the image forming apparatus 1. Residual toner 67 in the residual toner storage portion 65 moves toward a residual toner discharge port 62 by a rotation of the residual toner screw 18.

The residual toner discharge port 62 is provided on a downstream side in the direction in which the process cartridge 7 is inserted into the image forming apparatus 1. The residual toner 67 in the residual toner storage portion 65 is conveyed to the downstream side in the direction in which the process cartridge 7 is inserted into the image forming apparatus 1 (to the rear side of the image forming apparatus 1) by the rotation of the residual toner screw 18. The conveyed residual toner is discharged out of the process cartridge 7 from the residual toner discharge port 62, and passes through a residual toner conveyance route (not illustrated) provided in the main body of the image forming apparatus 1 and is handed over to a residual toner unit 63 (refer to FIG. 1).

In the present embodiment, the lengths of the residual toner storage portion 65 in the X direction, the Z direction, and the Y direction are 230 mm, 40 mm, and 10 mm, respectively. The size of the residual toner discharge port 62 is 7 mm×7 mm. Increasing the sizes of the residual toner storage portion 65 and the residual toner discharge port 62 can make it less likely for the residual toner 67 to partially exceed the capacity of the residual toner storage portion 65 to spill out therefrom, but leads to a size increase of the photosensitive drum unit 9 and thus is not desirable from the space saving perspective.

### <Residual Toner Leak>

A residual toner leak will be described with reference to FIGS. 4, 6A, and 6B.

When the height of the residual toner 67 reaches the height of the collection sheet member 64, this makes it impossible to collect the residual toner 67 into the residual toner storage portion 65 and leads to generation of a gap between the photosensitive drum D and the collection sheet member 64, thereby causing a residual toner leak. Assuming that Tz and Tout are defined to represent the maximum height of the residual toner 67 and the height of the residual toner 67 when a residual toner leak occurs, respectively, a residual toner leak can be prevented by satisfying Tz<Tout. Tz is determined based on the amount and the position of the transfer residual toner and the conveyance amount of the residual toner screw 18.

When the amount of the transfer residual toner is great, Tz increases. Further, as illustrated in FIG. 6B, as a large amount of transfer residual toner is present at a position closer to the end portion of the residual toner storage portion 65, Tz increases because a heap of the residual toner 67 bumps against the wall of the residual toner storage portion 65, which makes it difficult for the heap to collapse on the wall side thereof.

On the other hand, an increase in the conveyance amount of the residual toner screw 18 can reduce Tz. However, an increase in the conveyance amount of the residual toner screw 18 more than desired may cause the conveyance amount of the residual toner screw 18 to undesirably exceed the amount that can be discharged from the residual toner discharge port 62, thereby causing the residual toner discharge port 62 to be clogged with the residual toner 67. When the residual toner discharge port 62 is clogged with the residual toner 67, the residual toner 67 cannot be conveyed out of the residual toner storage portion 65, and therefore a residual toner leak occurs at a timing when the residual toner 67 reaches Tz>Tout.

<Positional Relationship between Residual Toner Discharge Port and Printing Region of Bonding Layer>

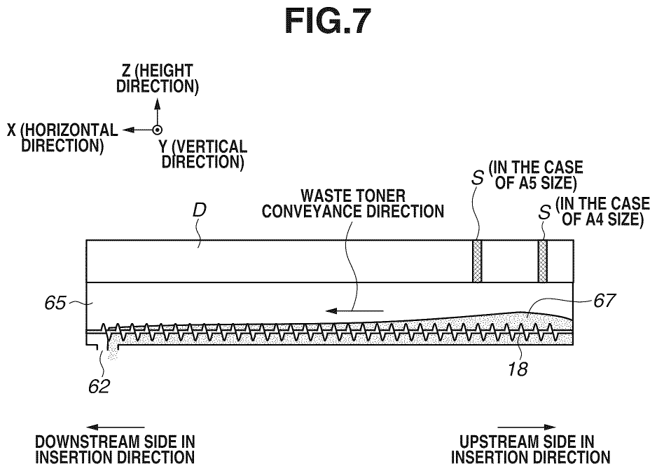

The positional relationship between the residual toner discharge port 62 and the printing region S of the bonding layer, which is a feature of the present embodiment, will be described with reference to FIG. 7. In the present embodiment, the residual toner discharge port 62 is disposed on the downstream side in the direction in which the process cartridge 7 is inserted into the image forming apparatus 1 (the rear side of the image forming apparatus 1), and the image is formed in such a manner that the printing region S of the bonding layer is located on the upstream side in the direction in which the process cartridge 7 is inserted into the image forming apparatus 1 (the front side of the image forming apparatus 1). The position of the printing region S of the bonding layer varies depending on the paper size. The printing region S of the bonding layer is located at a position closest to the central position of the photosensitive drum D when paper in A5 size, which is the smallest size, is bonded, and is located at a position farthest from the central position of the photosensitive drum D when paper in A4 size is bonded. In other words, the printing region S of the bonding layer is formed on one side in the longitudinal direction (a rotational axis direction of the photosensitive drum D), and the residual toner discharge port 62 is disposed on the other side of the residual toner storage portion 65 in the longitudinal direction. Further, this can also be said to be the thermocompression bonding unit 51 being disposed on one side in the longitudinal direction and the residual toner discharge port 62 being disposed on the other side of the residual toner storage portion 65 in the longitudinal direction. At the time of booklet manufacturing, a large amount of toner is constantly supplied from the development roller 17 at the longitudinal position of the printing region S of the bonding layer on the photosensitive drum D.

When a large amount of toner is supplied from the development roller 17 onto the photosensitive drum D, the transfer residual toner on the photosensitive drum D also increases. When the transfer residual toner on the photosensitive drum D increases, the residual toner removed by the cleaning blade 11 increases, and the residual toner collected at a longitudinal part in the residual toner storage portion 65 increases. Disposing the residual toner discharge port 62 on the longitudinally opposite side of the residual toner storage portion 65 from the printing region S of the bonding layer allows a large amount of residual toner collected at the position of the printing region S of the bonding layer to be conveyed to the residual toner discharge port 62 while being loosened by the residual toner screw 18. As a result, Tz<Tout can be satisfied, and the residual toner can be prevented from leaking out of the photosensitive drum unit 9.

The present embodiment has been described citing the configuration in which the residual toner discharge port 62 is disposed on the downstream side in the direction in which the process cartridge 7 is inserted into the image forming apparatus 1 and the image is formed in such a manner that the printing region S of the bonding layer is located on the upstream side in the direction in which the process cartridge 7 is inserted into the image forming apparatus 1 by way of example, but the present disclosure is not limited thereto. Similar advantageous effects can be achieved regardless of the insertion direction of the process cartridge 7 by arranging the positions of the residual toner discharge port 62 and the printing region S of the bonding layer longitudinally opposite from each other.

### Experiment for Evaluation of Present Embodiment

The following experiment was conducted with respect to the present embodiment. Manufacturing of a booklet containing 50 sheets was repeated a plurality of times, and the presence or absence of a residual toner leak out of the photosensitive drum unit 9 was compared. Evaluation conditions were as follows. Under an environment with 23° C. and 50% relative humidity (Rh), booklets were manufactured by forming an image designed for the experiment on the sheet P and repeating the manufacturing of a booklet containing 50 sheets 2000 times. After that, the presence or absence of a residual toner leak out of the photosensitive drum unit 9 was compared. In the present embodiment, a horizontal line at an image coverage of 0.5% was used as the image designed for the experiment. Further, the paper types of the largest A4 size and the smallest A5 size were each used as the sheet P.

In comparison example 1, the printing region S of the bonding layer was disposed on the rear side of the image forming apparatus 1 (the downstream side in the attachment direction of the process cartridge 7) in such a manner that the residual toner discharge port 62 and the printing region S of the bonding layer were arranged on the same side in the longitudinal direction. Other configurations were similar to the first embodiment.

### Result of Evaluation of Present Embodiment

Table 1 indicates a result of evaluating the presence or absence of a residual toner leak out of the photosensitive drum unit 9. In table 1, x indicates that a residual toner leak occurred, and ∘ indicates that no residual toner leak occurred.

TABLE 1

| | Sheet | |
|---|---|---|
| | Size | Residual Toner Leak |
| First Embodiment | A4 | ∘ |
| | A5 | ∘ |
| Comparison Example 1 | A4 | x (800th booklet manufacturing) |
| | A5 | x (1400th booklet manufacturing |

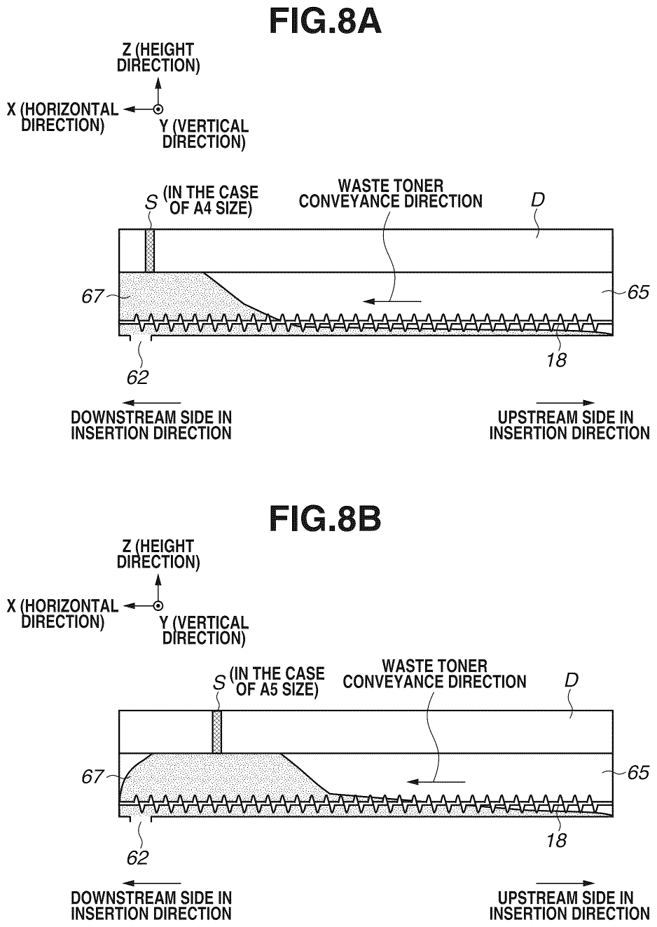

In comparison example 1, the large amount of residual toner collected at the position of the printing region S of the bonding layer was unable to be loosened by the residual toner screw 18 and the residual toner was conveyed to the residual toner discharge port 62 in a large amount in a short time as illustrated in FIGS. 8A and 8B. As a result, the residual toner discharge port 62 was clogged with the residual toner and the residual toner reached Tz≥Tout, and therefore a residual toner leak out of the photosensitive drum unit 9 occurred. In the case of the A4 size, the position of the printing region S of the bonding layer and the longitudinal position of the residual toner discharge port 62 were closely located as illustrated in FIG. 8A, and therefore a residual toner leak occurred at a timing earlier than in the case of the A5 size (the 800th booklet manufacturing). In the case of the A5 size, the heap of the residual toner 67 was located farther away from the residual toner discharge port 62 than in the case of the A4 size as illustrated in FIG. 8B, and this made it easier to loosen the heap of the residual toner 67 by the residual toner screw 18. Further, the transfer residual toner per sheet also reduced due to the small sheet size. However, the heap of the residual toner 67 still failed to be sufficiently loosened and the residual toner discharge port 62 was clogged with the residual toner, and a residual toner leak occurred at the time of the 1400th booklet manufacturing.

On the other hand, in the first embodiment, the residual toner 67 was able to be conveyed to the residual toner discharge port 62 disposed on the longitudinally opposite side while the large amount of residual toner collected at the longitudinal position of the printing region S of the bonding layer on the photosensitive drum D was loosened by the residual toner screw (the conveyance member) 18. As a result, the residual toner discharge port 62 was prevented from being clogged and Tz<Tout was satisfied, and therefore a residual toner leak out of the photosensitive drum unit 9 was able to be prevented.

The present embodiment has been described citing the configuration in which the collection sheet member 64 is disposed above the photosensitive drum D in the direction of gravitational force and the cleaning blade 11 is disposed below the photosensitive drum D in the direction of gravitational force by way of example, but the present disclosure is not limited thereto. Similar advantageous effects can also be achieved even when the collection sheet member 64 is disposed below the photosensitive drum D in the direction of gravitational force and the cleaning blade 11 is disposed above the photosensitive drum D in the direction of gravitational force.

### Second Embodiment

In a second embodiment, the size of the photosensitive drum unit 9 is reduced compared with the first embodiment in pursuit of the compactness of the photosensitive drum unit 9. This case may lead to a reduction in the capacity of the residual toner storage portion 65 that can collect the residual toner, resulting in a residual toner leak from the longitudinal end portion of the photosensitive drum unit 9.

Therefore, the present embodiment is especially directed to providing an image forming apparatus capable of preventing the residual toner from leaking from the longitudinal end portion of the photosensitive drum unit 9 with a simple configuration.

Redundant descriptions will be omitted for portions whose descriptions overlap those of the first embodiment.

### <Residual Toner Receiving Member>

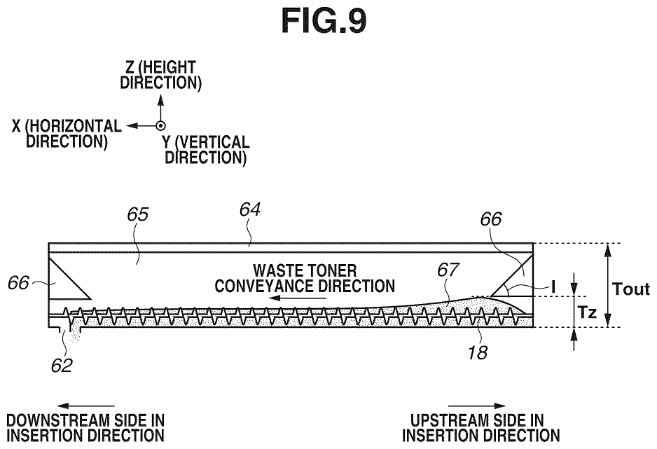

A residual toner receiving member 66, which is a difference from the first embodiment, will be described with reference to FIG. 9. The residual toner receiving member 66 is disposed at the end portion of the residual toner storage portion 65. The residual toner receiving member 66 is such a member that a surface thereof receiving the residual toner 67 is inclined downward toward the lower side in the Z direction (the lower side in the direction of gravitational force) and the inner side of the residual toner storage portion 65 in the X direction as illustrated in FIG. 9. The residual toner 67 dropped on the residual toner receiving member 66 slides down from the residual toner receiving member 66 and is dropped to a position distant from the end portion of the residual toner storage portion 65.

As described in the first embodiment, as a large amount of transfer residual toner is present at a position closer to the end portion of the residual toner storage portion 65, Tz increases because the heap of the residual toner 67 bumps against the wall of the residual toner storage portion 65, which makes it difficult for the heap to collapse on the wall side thereof. Especially, when the printing region S of the bonding layer is located at the end portion of the residual toner storage portion 65 (when A4-size paper is bonded), Tz increases. Therefore, at least when the printing region S of the bonding layer is located on the outermost end side, the heap of the residual toner 67 is separated away from the end portion of the residual toner storage portion 65 by arranging the position of the printing region S of the bonding layer and the position of the residual toner receiving member 66 so as to overlap each other as viewed in a direction intersecting with the rotational axis direction. Separating the heap of the residual toner 67 away from the end portion of the residual toner storage portion 65 can make it easy to collapse the heap of the residual toner 67, thereby suppressing an increase in Tz.

In the present embodiment, the lengths of the residual toner receiving member 66 in the X direction, the Z direction, and the Y direction are 15 mm, 15 mm, and 10 mm, respectively, and an angle I with respect to the horizontal plane in the X direction is 45°. Further, the residual toner storage portion 65 has smaller lengths in the Z direction and the X direction than in the first embodiment, and the lengths thereof in the X direction, the Z direction, and the Y direction are 220 mm, 30 mm, and 10 mm, respectively. The angle I of the residual toner receiving member 66 with respect to the horizontal plane in the X direction is not limited thereto, and may be any angle large than the angle of repose of the residual toner 67. Further, the residual toner receiving member 66 may be a plate-like member operable to drop the residual toner 67 to a position distant from the end portion.

### Experiment for Evaluation of Present Embodiment

The following experiment was conducted with respect to the present embodiment. Manufacturing of a booklet containing 50 sheets was repeated a plurality of times, and the presence or absence of a residual toner leak out of the photosensitive drum unit 9 was compared. Evaluation conditions were as follows. Under an environment with 23° C. and 50% relative humidity (Rh), booklets were manufactured by forming an image designed for the experiment on the sheet P and repeating the manufacturing of a booklet containing 50 sheets 2000 times. After that, the presence or absence of a residual toner leak out of the photosensitive drum unit 9 was compared. In the present embodiment, a horizontal line at an image coverage of 0.5% was used as the image designed for the experiment. Further, the paper types of the largest A4 size and the smallest A5 size were each used as the sheet P.

In comparison example 2, the printing region S of the bonding layer was disposed on the rear side of the image forming apparatus 1 (the downstream side in the attachment direction of the process cartridge 7) in such a manner that the residual toner discharge port 62 and the printing region S of the bonding layer were arranged on the same side in the longitudinal direction. Other configurations were similar to those of the second embodiment.

### Result of Evaluation of Present Embodiment

Table 2 indicates a result of evaluating the presence or absence of a residual toner leak out of the photosensitive drum unit 9. In table 2, x indicates that a residual toner leak occurred, and ∘ indicates that no residual toner leak occurred.

TABLE 2

| | Sheet | |
|---|---|---|
| | Size | Residual Toner Leak |
| Second Embodiment | A4 | ∘ |
| | A5 | ∘ |
| Comparison Example 2 | A4 | x (700th booklet manufacturing) |
| | A5 | x (1100th booklet manufacturing) |

In comparison example 2, the large amount of residual toner collected at the position of the printing region S of the bonding layer was unable to be loosened by the residual toner screw 18 and the residual toner was conveyed to the residual toner discharge port 62 in a large amount in a short time. As a result, the residual toner discharge port 62 was clogged with the residual toner and the residual toner reached Tz≥Tout, and therefore a residual toner leak out of the photosensitive drum unit 9 occurred, similarly to comparison example 1. The capacity of the residual toner storage portion 65 in comparison example 2 was smaller than that in comparison example 1, and therefore a residual toner leak occurred at an earlier timing.

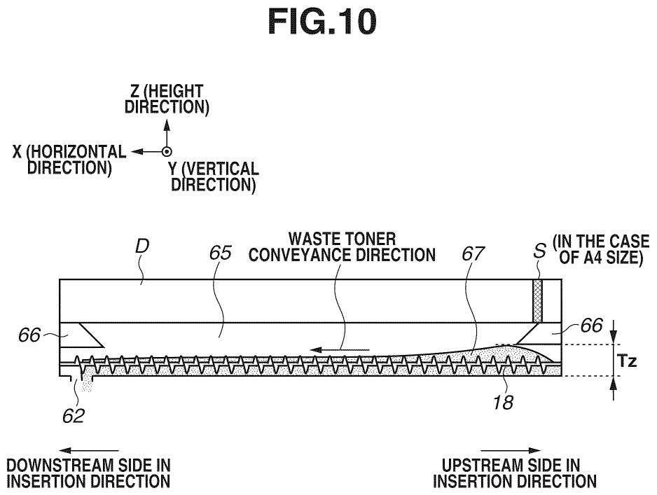

On the other hand, in the second embodiment, the residual toner 67 was able to be conveyed to the residual toner discharge port 62 disposed on the longitudinally opposite side while the large amount of residual toner collected at the longitudinal position of the printing region S of the bonding layer on the photosensitive drum D was loosened by the residual toner screw 18. As a result, the residual toner discharge port 62 was prevented from being clogged and Tz<Tout was satisfied, and therefore a residual toner leak out of the photosensitive drum unit 9 was able to be prevented. Further, in the case of the A4 size, overlapping the position of the printing region S of the bonding layer and the position of the residual toner receiving member 66 made it easier to collapse the heap of the residual toner 67, thereby making it possible to suppress an increase in Tz as illustrated in FIG. 10. As a result, the residual toner can be prevented from leaking out from the longitudinal end portion of the photosensitive drum unit 9.

### SUPPLEMENTARY NOTES

Further, the disclosure of the present embodiments includes the following exemplary configurations and exemplary methods.

### Item 1

An image forming system comprising:
a rotatable image bearing member;
a development unit configured to be able to supply toner to the image bearing member and develop a toner image and a bonding toner image;
a transfer unit configured to transfer the toner image on the image bearing member to a recording material;
a collection member configured to collect residual toner remaining on the image bearing member without being transferred to the recording material;
a residual toner storage portion configured to store the residual toner collected by the collection member and including a toner discharge port for discharging the residual toner, the toner discharge port being provided on one side in a rotational axis direction of the image bearing member; and
a conveyance member configured to convey the residual toner toward the toner discharge port by moving the residual toner stored in the residual toner storage portion in the rotational axis direction,
wherein the bonding toner image transferred to the recording material by the transfer unit bonds a plurality of recording media, and this allows a booklet to be manufactured, and
wherein the bonding toner image is formed at an end portion of the recording material that is located on the other side in the rotational axis direction.

### Item 2

The image forming system according to item 1,
wherein the residual toner storage portion includes a toner receiving member configured to receive the residual toner dropped in a direction of gravitational force when the residual toner is collected from the image bearing member, and
wherein the toner receiving member is disposed on the other side of the residual toner storage portion in the rotational axis direction.

### Item 3

The image forming system according to item 1 or 2, wherein, in a case where there is a plurality of positions in the rotational axis direction at which the bonding toner image is formed on the recording material, at least the bonding toner image located at an outermost end portion in the rotational axis direction and the toner receiving member overlap each other as viewed in a direction intersecting with the rotational axis direction.

### Item 4

The image forming system according to any one of items 1 to 3, wherein a surface of the toner receiving member that receives the residual toner is inclined toward a lower side in the direction of gravitational force and a center of the residual toner storage portion in the rotational axis direction.

### Item 5

The image forming system according to any one of items 1 to 4, wherein an inclination angle of the surface of the toner receiving member that receives the residual toner is larger than an angle of repose of the toner stored in the residual toner storage portion.

### Item 6

A booklet manufacturing apparatus that is connectable to an image forming apparatus including:
a rotatable image bearing member;
a development unit configured to be able to supply toner to the image bearing member and develop a toner image and a bonding toner image;
a transfer unit configured to transfer the toner image on the image bearing member to a recording material;
a collection member configured to collect residual toner remaining on the image bearing member without being transferred to the recording material;
a residual toner storage portion configured to store the residual toner collected by the collection member and including a toner discharge port for discharging the residual toner, the toner discharge port being provided on one side in a rotational axis direction of the image bearing member; and
a conveyance member configured to convey the residual toner toward the toner discharge port by moving the residual toner stored in the residual toner storage portion in the rotational axis direction, and
that includes a heater configured to heat the bonding toner image,
wherein a booklet is manufactured by heating the bonding toner image transferred to the recording material by the transfer unit using the heater and bonding a plurality of recording media using a bonding force of the heated bonding toner image, and
wherein the heater is disposed on the other side in the rotational axis direction.

### Item 7

The booklet manufacturing apparatus according to item 6,
wherein the residual toner storage portion includes a toner receiving member configured to receive the residual toner dropped in a direction of gravitational force when the residual toner is collected from the image bearing member, and
wherein the toner receiving member is disposed on the other side of the residual toner storage portion in the rotational axis direction.

### Item 8

The booklet manufacturing apparatus according to item 6 or 7, wherein, in a case where there is a plurality of positions in the rotational axis direction at which the bonding toner image is formed on the recording material, at least the bonding toner image located at an outermost end portion in the rotational axis direction and the toner receiving member overlap each other as viewed in a direction intersecting with the rotational axis direction.

### Item 9

The booklet manufacturing apparatus according to any one of items 6 to 8, wherein a surface of the toner receiving member that receives the residual toner is inclined toward a lower side in the direction of gravitational force and a center of the residual toner storage portion in the rotational axis direction.

### Item 10

The booklet manufacturing apparatus according to any one of items 6 to 9, wherein an inclination angle of the surface of the toner receiving member that receives the residual toner is larger than an angle of repose of the toner stored in the residual toner storage portion.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-025405, filed Feb. 19, 2025, which is hereby incorporated by reference herein in its entirety.

What is claimed is:

1. An image forming system comprising:
a rotatable image bearing member;
a development unit configured to be able to supply toner to the image bearing member and develop a toner image and a bonding toner image;
a transfer unit configured to transfer the toner image on the image bearing member to a recording material;
a collection member configured to collect residual toner remaining on the image bearing member without being transferred to the recording material;
a residual toner storage portion configured to store the residual toner collected by the collection member and including a toner discharge port for discharging the residual toner, the toner discharge port of the residual toner storage portion being provided on one side in a rotational axis direction of the image bearing member; and
a conveyance member configured to convey the residual toner toward the toner discharge port by moving the residual toner stored in the residual toner storage portion in the rotational axis direction,
wherein the bonding toner image transferred to the recording material by the transfer unit bonds a plurality of recording media, and this allows a booklet to be manufactured, and
wherein the bonding toner image is formed at an end portion of the recording material that is located on the other side in the rotational axis direction.

2. The image forming system according to claim 1,
wherein the residual toner storage portion includes a toner receiving member configured to receive the residual toner dropped in a direction of gravitational force when the residual toner is collected from the image bearing member, and
wherein the toner receiving member is disposed on the other side of the residual toner storage portion in the rotational axis direction.

3. The image forming system according to claim 2, wherein, in a case where there is a plurality of positions in the rotational axis direction at which the bonding toner image is formed on the recording material, at least the bonding toner image located at an outermost end portion in the rotational axis direction and the toner receiving member overlap each other as viewed in a direction intersecting with the rotational axis direction.

4. The image forming system according to claim 2, wherein a surface of the toner receiving member that receives the residual toner is inclined toward a lower side in the direction of gravitational force and a center of the residual toner storage portion in the rotational axis direction.

5. The image forming system according to claim 4, wherein an inclination angle of the surface of the toner receiving member that receives the residual toner is larger than an angle of repose of the toner stored in the residual toner storage portion.

6. A booklet manufacturing apparatus that is connectable to an image forming apparatus including:
a rotatable image bearing member;
a development unit configured to be able to supply toner to the image bearing member and develop a toner image and a bonding toner image;
a transfer unit configured to transfer the toner image on the image bearing member to a recording material;
a collection member configured to collect residual toner remaining on the image bearing member without being transferred to the recording material;
a residual toner storage portion configured to store the residual toner collected by the collection member and including a toner discharge port for discharging the residual toner, the toner discharge port of the residual toner storage portion being provided on one side in a rotational axis direction of the image bearing member; and
a conveyance member configured to convey the residual toner toward the toner discharge port by moving the residual toner stored in the residual toner storage portion in the rotational axis direction, and
that includes a heater configured to heat the bonding toner image,
wherein a booklet is manufactured by heating the bonding toner image transferred to the recording material by the transfer unit using the heater and bonding a plurality of recording media using a bonding force of the heated bonding toner image, and
wherein the heater is disposed on the other side in the rotational axis direction.

7. The booklet manufacturing apparatus according to claim 6,
wherein the residual toner storage portion includes a toner receiving member configured to receive the residual toner dropped in a direction of gravitational force when the residual toner is collected from the image bearing member, and
wherein the toner receiving member is disposed on the other side of the residual toner storage portion in the rotational axis direction.

8. The booklet manufacturing apparatus according to claim 7, wherein, in a case where there is a plurality of positions in the rotational axis direction at which the bonding toner image is formed on the recording material, at least the bonding toner image located at an outermost end portion in the rotational axis direction and the toner receiving member overlap each other as viewed in a direction intersecting with the rotational axis direction.

9. The booklet manufacturing apparatus according to claim 7, wherein a surface of the toner receiving member that receives the residual toner is inclined toward a lower side in the direction of gravitational force and a center of the residual toner storage portion in the rotational axis direction.

10. The booklet manufacturing apparatus according to claim 9, wherein an inclination angle of the surface of the toner receiving member that receives the residual toner is larger than an angle of repose of the toner stored in the residual toner storage portion.
